(19) United States
(12) Patent Application Publication
(10) Pub. No.: US 2023/0099891 A1
(43) Pub. Date: Mar. 30, 2023

(54) DETACHER FOR CHAIN QUICK LINK

(71) Applicant: BETO ENGINEERING & MARKETING CO., LTD., Taichung City (TW)

(72) Inventor: Lopin WANG, Taichung City (TW)

(21) Appl. No.: 17/545,590

(22) Filed: Dec. 8, 2021

(30) Foreign Application Priority Data
Sep. 30, 2021 (TW) 110136438

(51) Int. Cl. B25B 27/22; B25B 27/00

(52) U.S. Cl. CPC B25B 27/22; B25B 27/0071; F16G 15/04

(57) ABSTRACT

The invention relates to a detacher for chain quick link comprising: a main body with a first end and a second end, the main body has a fixed jaw; a driving member with a screw portion screwed into a screw hole provided at the first end of the main body, when the driving member is rotated, the driving member is capable of displacing toward the second end of the main body; and a sliding member displaceably installed in the main body, a movable jaw of the sliding member corresponds to the fixed jaw; when the driving member displaces toward the second end of the main body, the sliding member is driven to displace toward the second end of the main body together, so that the movable jaw moves toward the fixed jaw for disassembling a quick-linked chain.

### BACKGROUND OF THE INVENTION

### Field of Invention

The invention relates to a hand tool used for bicycles, in detail, it refers to a detacher for disassembling a quick-linked chain.

### Related Art

Bicycle chain is a commonly used transmission component for bicycles. In order to facilitate bicycle users to easily disassemble and assemble bicycle chains, chain manufacturers have developed a quick-linked chain. The quick-linked chain has a pair of fasten plates for quick detaching from the chain pin of a chain and fastening with the chain pin to make the disassembly, assembly and replacement of the chain more convenient.

The above-mentioned fasten plates of the quick-linked chain must be disassembled or fastened with a special plier for quick link, as shown in FIG. 1A to FIG. 2B of Taiwan utility model No. M408455.

Although the plier for quick link is a special tool for disassembling the quick-linked chain, the plier has a certain volume, which is not convenient to be carried around by bicycle riders. With innovation being emphasized on products nowadays, the invention aims to propose a different type of hand tool for disassembling quick-linked chains.

In addition, chain breaker is a bicycle tool used to break the chain links of a chain to adjust the tightness of the chain. The plier for quick link and the chain breaker are different types of bicycle tools, and they are different in operation and purpose. In order to replace and disassemble a chain, it would be very inconvenient for bicycle riders to bring the plier for quick link and the chain breaker along with them when cycling.

### SUMMARY OF THE INVENTION

The invention aims to solve the above-mentioned drawbacks, and its object is to provide a detacher for chain quick link, which is an innovative bicycle tool for disassembling quick-linked chains.

Another object of the invention is to provide a detacher for chain quick link, the detacher is not only capable of disassembling quick-linked chains, but also has the function of a chain breaker.

Yet another object of the invention is to provide a detacher for chain quick link, which can also be used for assembling quick-linked chains.

The detacher for chain quick link provided by the invention comprises:

a main body having a first end and a second end, a moving direction is formed between the first end and the second end; a fixed jaw is disposed on the main body;

a driving member having a screw portion, the screw portion is screwed into a screw hole provided at the first end of the main body, when the driving member is rotated, the driving member is capable of displacing along the moving direction toward the second end of the main body; and

a sliding member installed in the main body and capable of displacing along the moving direction; a movable jaw is disposed on the sliding member and corresponds to the fixed jaw; when the driving member displaces toward the second end of the main body, the sliding member is driven to displace toward the second end of the main body, so that the movable jaw moves toward the fixed jaw.

Thereby, the driving member linked with the sliding member together displace toward the second end of the main body, so that a distance between the movable jaw and the fixed jaw is shortened, thereby the movable jaw and the fixed jaw are capable of disassembling a quick-linked chain.

In one implementation, the driving member has a driving portion, and the driving portion drives the sliding member to displace toward the second end of the main body.

In one implementation, the driving member forms the driving portion with one end of the screw portion facing the second end of the main body.

In one implementation, the main body has a slideway disposed along the moving direction; the sliding member is disposed in the slideway.

In one implementation, the driving member is provided with a pin at one end of the screw portion facing the second end of the main body, and the pin is inserted into the sliding member to restrain the sliding member.

In one implementation, the fixed jaw is provided on a bottom side of the main body; the movable jaw passes through a through groove of the main body to reach the bottom side of the main body.

In one implementation, the sliding member is provided with a perforation, the perforation is provided along the moving direction and penetrates through the sliding member; one end of the screw portion facing the second end of the main body is provided with a pin along an axial direction of the screw portion, the pin is inserted into the perforation of the sliding member and protrudes from the sliding member; an accommodating space is disposed on a top side of the main body; when the driving member displaces toward the second end of the main body, the pin is capable of moving into the accommodating space; a receiving chamber is disposed at the second end of the main body and located in an axial direction of the pin.

With the above structure, the detacher can be used to break the chain, so that the detacher has the function of a chain breaker.

In one implementation, the driving member drives the sliding member to displace toward the first end of the main body together, so that the movable jaw is away from the fixed jaw. Thereby, a distance between the movable jaw and the fixed jaw is increased for assembling the quick-linked chain.

In one implementation, the sliding member is provided with a perforation along the moving direction; the screw portion is provided with a pin at one end facing the second end of the main body, the pin is inserted into the perforation of the sliding member; a second driving portion is provided on the pin, the driving member drives the sliding member to displace toward the first end via the second driving portion.

In one implementation, the main body is provided with a grip for an operator to hold; or the main body is provided with a pivotal portion so that the detacher can be pivotally connected to a folding tool set as one of the tools of the folding tool set.

### BRIEF DESCRIPTION OF THE DRAWINGS

The objects, features, and achieved efficacies of the invention can be understood from the description and drawings of the following preferred embodiments, in which:

FIG. 1 is a perspective view of a detacher for chain quick link according to a preferred embodiment of the invention.

FIG. 2 is a rear perspective view of FIG. 1.

FIG. 3 is an exploded perspective view of FIG. 1.

FIG. 4 is a bottom view of FIG. 1.

FIG. 5 is a cross-sectional view taken along section line 5-5 of FIG. 1.

FIG. 6 is a cross-sectional view taken along section line 6-6 of FIG. 1.

FIG. 7 is a bottom perspective view of the detacher and a quick-linked chain of the invention.

FIG. 8 is a cross-sectional view taken along section line 8-8 of FIG. 7.

FIG. 9 is a diagram of using the detacher of the invention to disassemble the quick-linked chain.

FIG. 10 is a longitudinal cross-sectional view of FIG. 9.

FIGS. 11 and 12 are respectively a cross-sectional view and a diagram of using the detacher of the invention to connect and fasten the quick-linked chain.

FIGS. 13 and 14 are a state of using the detacher of the invention to break a chain.

FIGS. 15A and 15B are respectively a front perspective view and a rear perspective view of the detacher according to a second preferred embodiment of the invention.

FIGS. 16A and 16B are respectively an exploded perspective view and a perspective view of a folding tool set, in which the detacher of the invention is one of the tools of the folding tool set.

### DETAILED DESCRIPTION OF THE INVENTION

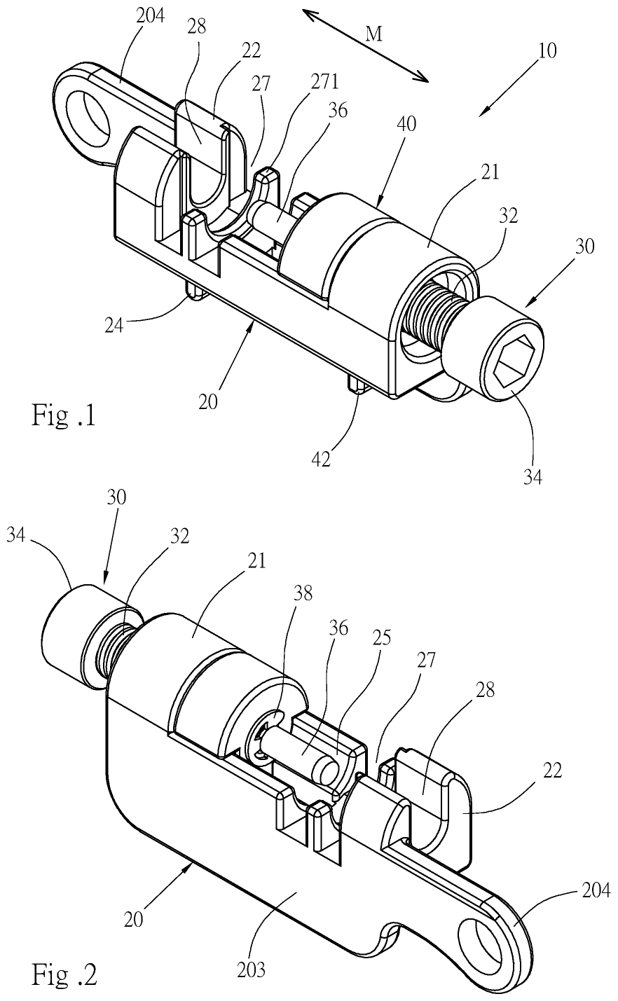

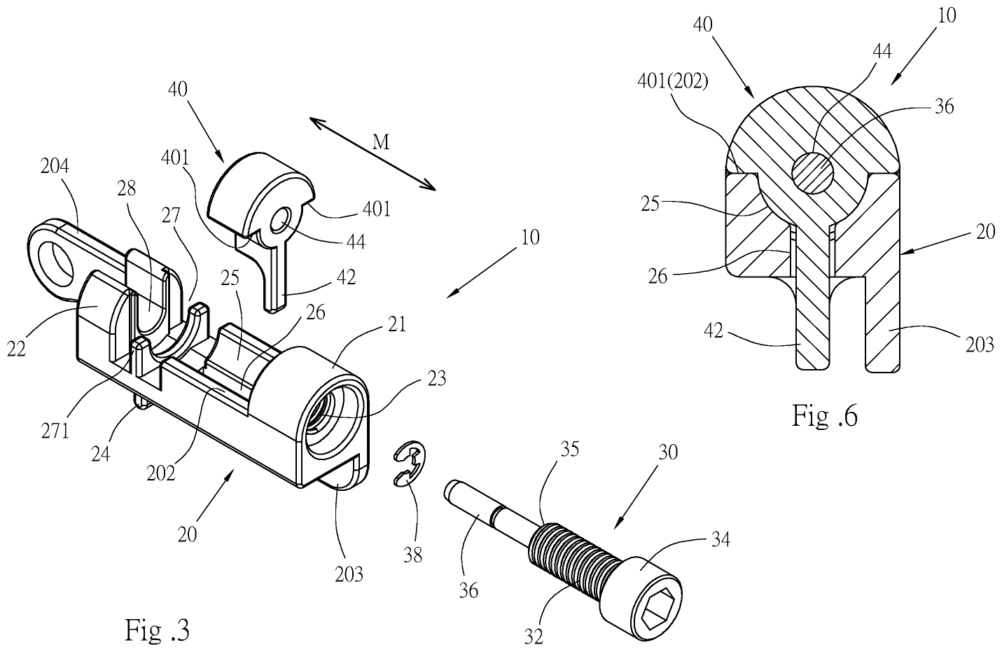

Please refer to FIGS. 1 to 4 for a detacher 10 for chain quick link provided by a preferred embodiment of the invention for disassembling a quick-linked chain. The detacher 10 comprises: a main body 20, a driving member 30, and a sliding member 40.

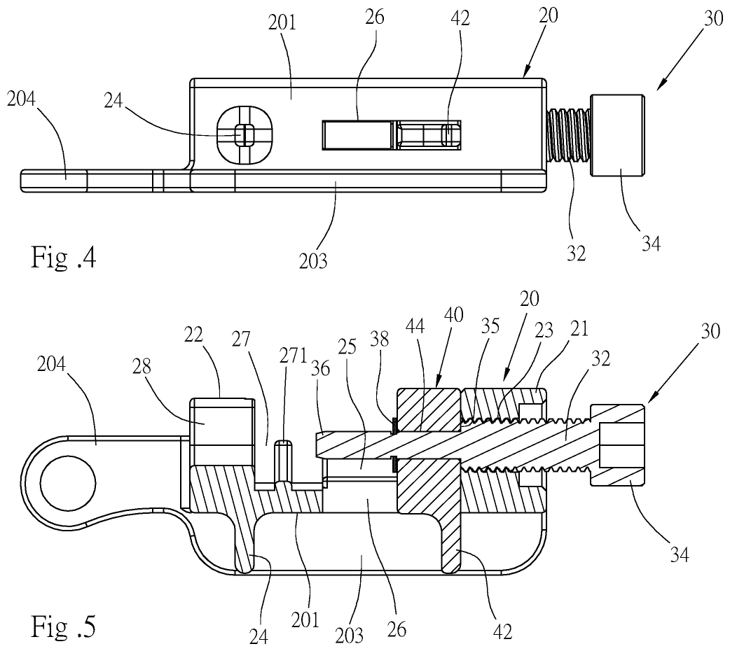

The main body 20 is generally an elongated body, two ends thereof are respectively a first end 21 and a second end 22, a moving direction M is formed between the first end 21 and the second end 22; a screw hole 23 is provided at the first end 21 of the main body 20; a fixed jaw 24, as shown in FIGS. 4 and 5, is provided on a peripheral surface of the main body 20. In this embodiment, the fixed jaw 24 protrudes downward from a bottom wall 201 of the main body 20. A slideway 25 is provided in the main body 20 and located between the first end 21 and the second end 22.

The driving member 30 is in the form of a screw member, and has a screw portion 32 and an operating end 34 located at an outer end of the screw portion 32. The screw portion 32 of the driving member 30 is screwed into the screw hole 23 of the first end 21 of the main body 20, an axial direction of the screw hole 23, an axial direction of the screw portion 32 and a direction of the slideway 25 are parallel to the moving direction M. The operating end 34 can be operated by hand tools such as a hexagonal wrench or an open-end wrench to rotate the driving member 30. The operating end 34 can be made into any form, such as an inner hexagonal hole or a hexagonal head, which is not limited by the form shown in the figures. When the driving member 30 is rotated clockwise or counterclockwise, the driving member 30 is driven to be capable of displacing forward towards or away from the second end 22 of the main body 20 along the moving direction M.

The sliding member 40 is installed in the slideway 25 of the main body 20 and capable of displacing along the moving direction M; a movable jaw 42 is provided on the sliding member 40 and corresponds to the fixed jaw 24 of the main body 20, as shown in FIG. 5. When the driving member 30 is rotated to displace toward the second end 22 of the main body 20, the driving member 30 will drive the sliding member 40 to move on the slideway 25, and the driving member 30 and the sliding member 40 will displace together along the moving direction M, the movable jaw 42 is caused to move toward the fixed jaw 24, and a distance between the fixed jaw 24 and the movable jaw 42 is shortened. Via a driving portion 35 the driving member 30 pushes the sliding member 40 to move toward the second end 22. In this embodiment, an inner end (that is, the end facing the second end 22) of the screw portion 32 serves as the driving portion 35. In this embodiment, the movable jaw 42 of the sliding member 40 passes downward through a through groove 26 of the main body 20 and protrudes from the bottom wall 201 of the main body 20 to correspond to the fixed jaw 24. The through groove 26 penetrates through a top side and a bottom side of the main body 20 so that the slideway 25 is communicated to the bottom side of the main body 20. A length direction of the through groove 26 is parallel to the moving direction M. Two sides of the sliding member 40 are abutted against two flat edges 202 of the main body 20 with two flanges 401, as shown in FIG. 6. The two flat edges 202 are respectively located on two sides of the slideway 25, so that the sliding member 40 is capable of moving on the main body 20 smoothly and stably.

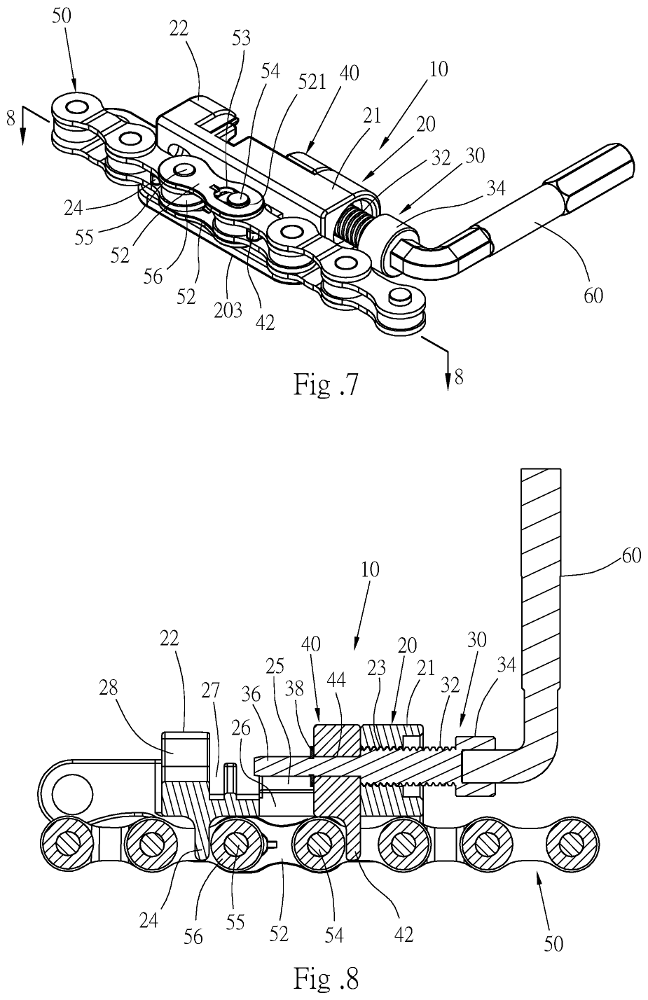

When the detacher 10 is used to disassemble a quick-linked chain 50, as shown in FIGS. 7 and 8, the detacher 10 is combined with the quick-linked chain 50. At this time, the sliding member 40 is close to the first end 21 of the main body 20, and there is a relatively large distance between the movable jaw 42 and the fixed jaw 24. The chain 50 has a pair of fasten plates 52. A chain link formed by the pair of fasten plates 52 has two fasten pins 54, 55, and the fasten pin 54 fastens with a fasten hole 521 of one of the fasten plates 52; similarly, the fasten pin 55 fastens with the fasten hole 521 of the other fasten plate 52, that is, the two fasten pins 54, 55 are located at a fastening position, two ends of the chain 50 is connected by the fasten plates 52. A vertical wall 203 is provided on one side of the main body 20, so that the chain 50 can be supported by the vertical wall 203 without bending.

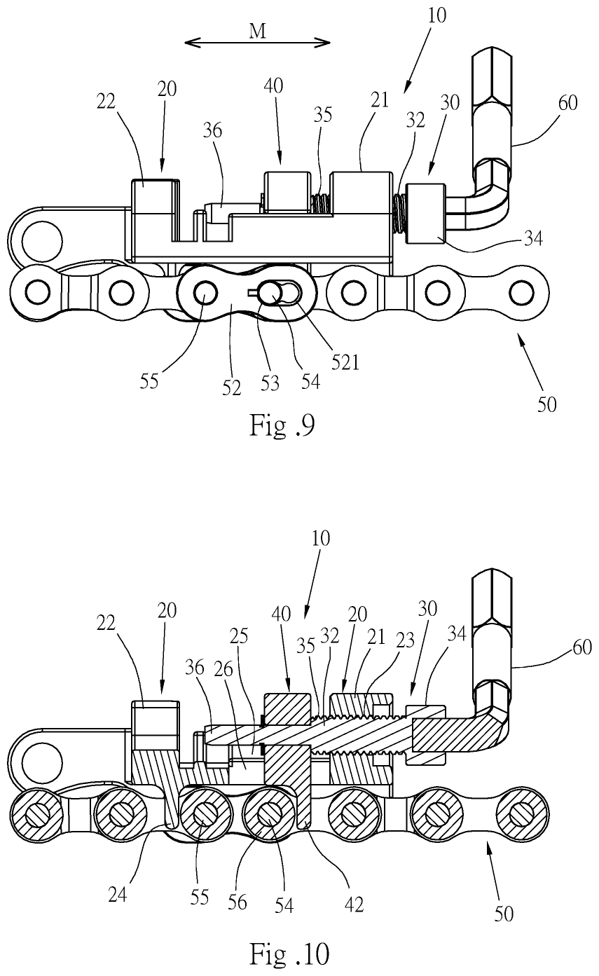

When disassembling the chain 50, the fixed jaw 24 and the movable jaw 42 are positioned to contact with outer sides of rollers 56 of the two fasten pins 54, 55, and a hand tool, such as a hexagonal wrench 60, is used to rotate the driving member 30 from the operating end 34, so that the driving member 30 is moved toward the second end 22 along the moving direction M, and the sliding member 40 is synchronously driven to move toward the second end 22. As a result, as shown in FIGS. 9 and 10, a distance between the movable jaw 42 and the fixed jaw 24 is shortened, and a distance between the two fasten pins 54, 55 of the chain 50 is shortened. The fasten pin 54 will be moved into a release hole 53 connected with the fasten hole 521 from the fasten hole 521 of one of the fasten plates 52; similarly, the fasten pin 55 will be moved into the other release hole 53 from the fasten hole 521 of the other fasten plate 52, and the two fasten pins 54, 55 are displaced to a release position. A diameter of the release hole 53 is larger than a diameter of the fasten pins 54, 55, so that the two fasten pins 54, 55 can be separated from the two fasten plates 52 respectively, thereby disconnecting the chain 50.

In this embodiment, the driving member 30 can further be provided with a pin 36 on an inner end of the screw portion 32 along the axial direction of the screw portion 32, and the pin 36 is inserted into the sliding member 40 from one end of the sliding member 40, it is not necessary for the pin 36 to protrude from another end of the sliding member 40. Thereby, the pin 36 serves as a design for restraining the sliding member 40, so that the sliding member 40 will not detach from the main body 20, and the pin 36 also has a function of stabilizing displacement of the sliding member 40.

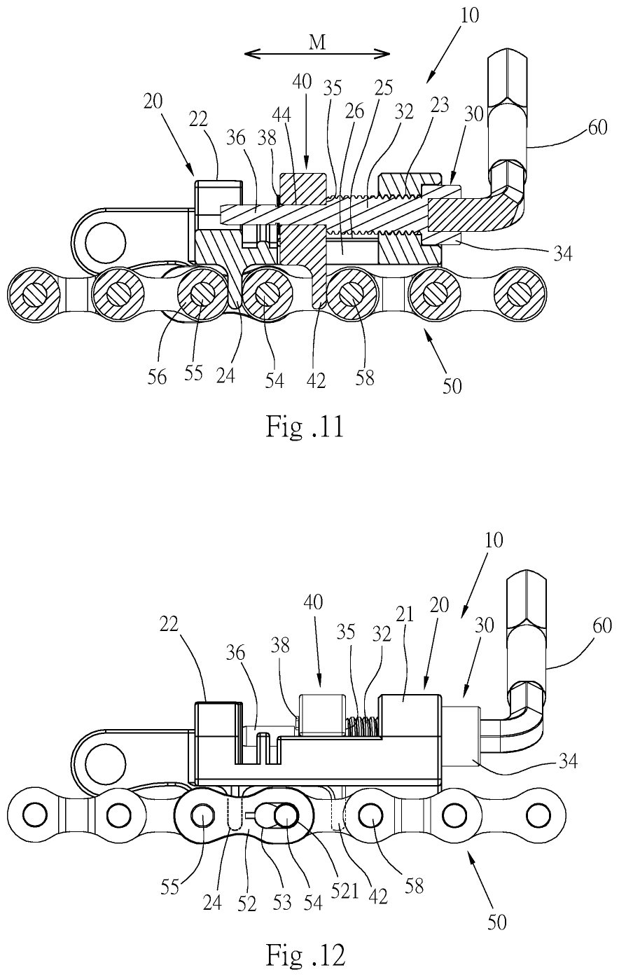

Please refer to FIG. 11 and FIG. 12. In another implementation of this embodiment, the detacher 10 can be used to assemble the quick-linked chain 50. In this implementation, the sliding member 40 is further provided with a perforation 44 along the moving direction M, and the perforation 44 penetrates through the two ends of the sliding member 40. And, a pin 36 is provided in the axial direction of the screw portion 32 of the driving member 30 and extends toward the second end 22 of the main body 20. The pin 36 is inserted into the perforation 44 of the sliding member 40 and protrudes from the sliding member 40. A fastener (such as a C-shaped fastener) or a similar element is installed on the pin 36 and abuts against one end of the sliding member 40. The fastener forms a second driving portion 38 of the driving member 30. When the driving member 30 moves toward the first end 21 of the main body 20, that is, moves in a direction away from the second end 22, with the second driving portion 38 abutting against the sliding member 40, the driving member 30 drives the sliding member 40 to displace toward the first end 21 of the main body 20 together. In this operation, the detacher 10 can be used to assemble the quick-linked chain 50. As shown in FIG. 11, the fasten pins 54, 55 of the two fasten plates 52 of the quick-linked chain 50 are located in the release position, and the sliding member 40 of the detacher 10 is close to the second end 22 of the main body 20, the fixed jaw 24 of the detacher 10 is positioned to contact with an inner side of the roller 56 of the fasten pin 55, and the movable jaw 42 is positioned to contact with a roller of a chain pin 58. Then, the driving member 30 is rotated so that the driving member 30 drives the sliding member 40 to move toward the first end 21 of the main body 20, a distance between the movable jaw 42 and the fixed jaw 24 is increased, and the two fasten pins 54, 55 are moved to the fastening position. As shown in FIG. 12, the two fasten pins 54, 55 move into the fasten holes 521 of the fasten plates 52 from the release holes 53 of the fasten plates 52 to fasten with the fasten holes 521 of the fasten plates 52 to complete assembly of the chain 50.

This embodiment further enables the detacher 10 to combine the function of a chain breaker. Please refer to FIGS. 1 to 3. In an implementation that also has the function of a chain breaker, the inner end of the screw portion 32 of the driving member 30 is extended with a pin 36 along the axial direction of the screw portion 32, and the sliding member 40 is provided with the perforation 44 penetrating through the two ends of the sliding member 40 along the moving direction M. The pin 36 of the driving member 30 is inserted into the perforation 44 of the sliding member 40 and protrudes from the sliding member 40, and a length of the pin 36 protruding from the sliding member 40 is not less than a width of the chain 50. The top side of the main body 20 is recessed inwardly with an accommodating space 27 located between the sliding member 40 and the second end 22 for accommodating the chain 50. Inside the accommodating space 27 is provided with a rib 271 to position the chain 50 inside the accommodating space 27. In addition, the second end 22 of the main body 20 is provided with a receiving chamber 28 located in an axial direction of the pin 36 and communicating with the accommodating space 27. When the driving member 30 displaces toward the second end 22, the pin 36 can be moved into the accommodating space 27.

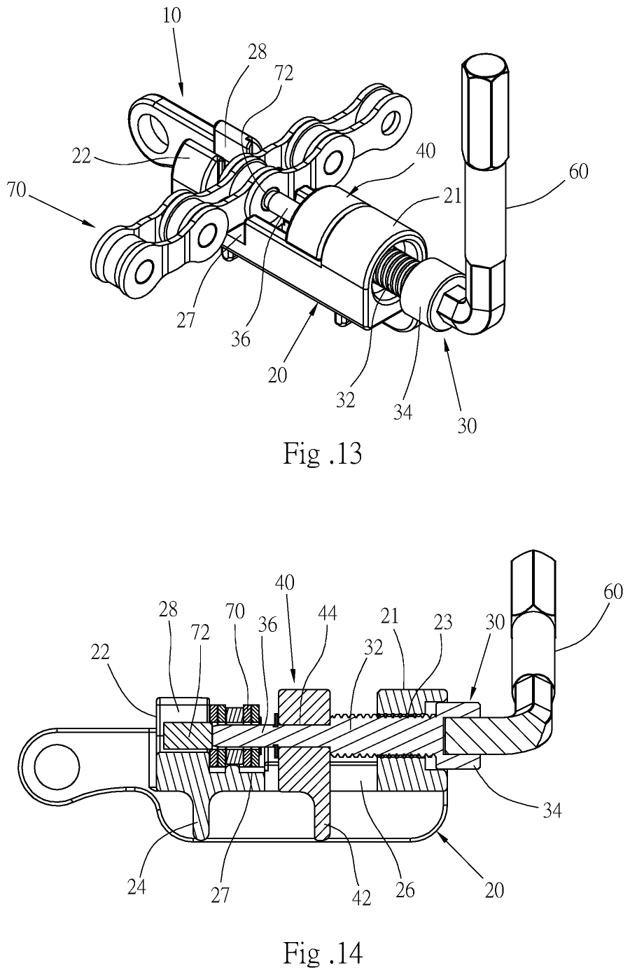

When the detacher 10 is used for breaking a chain, as shown in FIG. 13, a chain 70 is placed across the accommodating space 27, and the pin 36 of the driving member 30 is aligned with a chain pin 72 of the chain 70, and then a hand tool 60 is used to rotate the driving member 30 to move it toward the second end 22 of the main body 20. As shown in FIG. 14, the pin 36 of the driving member 30 is inserted into the chain 70, and the chain pin 72 is pushed out of the chain 70. The chain pin 72 that has been pushed out is moved into the receiving chamber 28. In this way, chain links of the chain 70 can be disconnected, thereby reducing or increasing a quantity of the chain links, and adjusting a length or a tightness of the chain 70.

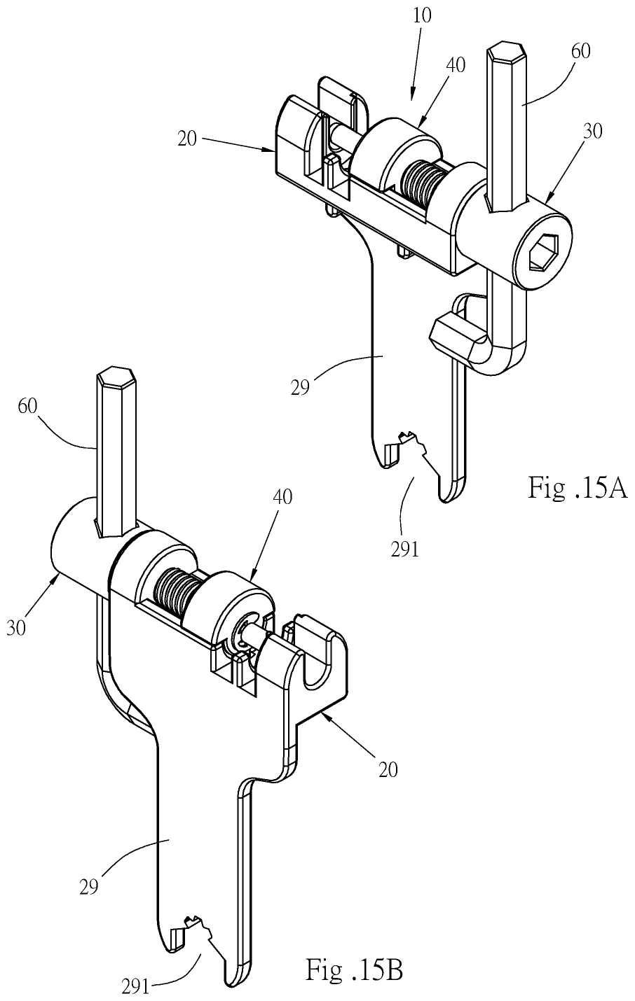

The detacher 10 can be made into a single hand tool or used as one of components of a folding tool set. FIGS. 15A and 15B show that the detacher 10 is a hand tool. The main body 20 can be connected to a grip or integrated into a grip 29 for a user to hold. A free end of the grip 29 can be provided with a polygonal fitting hole 291 for turning nuts or bolts.

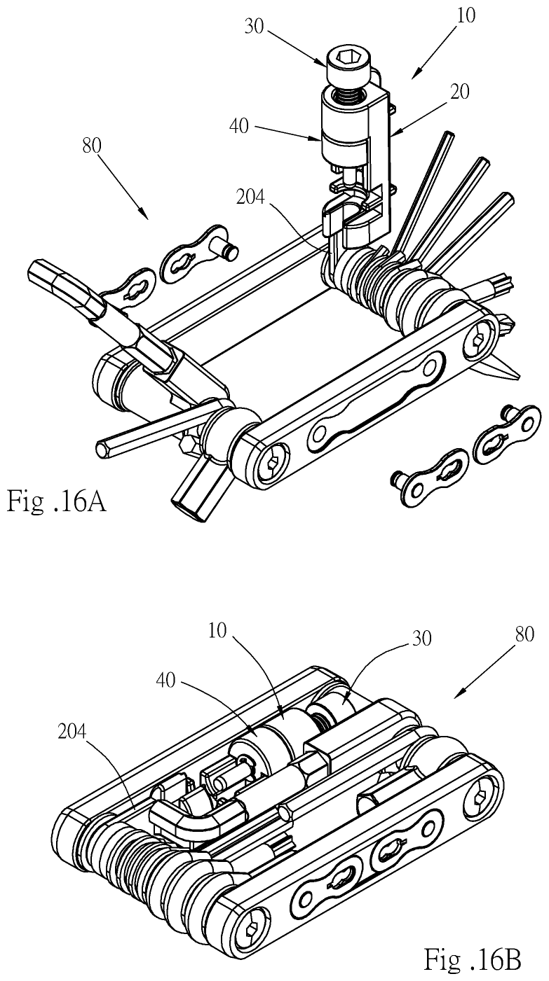

Or, as shown in FIG. 1, FIGS. 16A and 16B, the main body 20 has a pivotal portion 204, and the pivotal portion 204 is pivotally connected to a folding tool set 80, so that the detacher 10 becomes one of the tools of the folding tool set 80. Other tools of the folding tool set 80 are not subject matters of the invention and thus will not be described in detail.

The detacher of the invention is an innovative structure tool for disassembling and assembling the quick-linked chain, which is different from the conventional pliers for quick link. A size of the detacher is smaller than that of pliers for quick link, and it takes less space to carry around. Furthermore, the detacher of the invention perfectly integrates the function of the chain breaker, so that a single tool has the dual purposes of disassembling, assembling the quick-linked chain and breaking the chain, and the convenience and efficiency of use can be improved. Moreover, because the detacher of the invention has the functions of breaking the chain and disassembling, assembling the quick-linked chain, the folding tool set can be equipped with other types of tools, and the types of tools of the folding tool set can be increased.

It is to be understood that the above description is only the embodiments of the invention and is not used to limit the present invention, and changes in accordance with the concepts of the present invention may be made without departing from the spirit of the present invention. For example, the equivalent effects produced by various transformations, variations, modifications and applications made to the configurations or arrangements shall still fall within the scope covered by the appended claims of the present invention.

What is claimed is:

1. A detacher for chain quick link comprising:
a main body having a first end and a second end, a moving direction being formed between the first end and the second end; a screw hole being provided at the first end of the main body; a fixed jaw being disposed on the main body;
a driving member having a screw portion, the screw portion being screwed into the screw hole of the main body, when the driving member being rotated, the driving member being capable of displacing along the moving direction toward the second end of the main body; and
a sliding member installed in the main body and capable of displacing along the moving direction; a movable jaw being disposed on the sliding member and corresponding to the fixed jaw; when the driving member displacing toward the second end of the main body, the sliding member being driven to displace toward the second end of the main body, so that the movable jaw moving toward the fixed jaw.

2. The detacher as claimed in claim 1, wherein the driving member has a driving portion, and the driving portion drives the sliding member to displace toward the second end of the main body.

3. The detacher as claimed in claim 1, wherein the driving member forms the driving portion with one end of the screw portion facing the second end of the main body, and the driving portion contacts with the sliding member.

4. The detacher as claimed in claim 1, wherein the main body has a slideway disposed along the moving direction; the sliding member is disposed in the slideway.

5. The detacher as claimed in claim 1, wherein the driving member is provided with a pin at one end of the screw portion facing the second end of the main body, the pin protrudes toward the second end of the main body and is inserted into the sliding member.

6. The detacher as claimed in claim 2, wherein the driving member is provided with a pin at one end of the screw portion facing the second end of the main body, the pin protrudes toward the second end of the main body and is inserted into the sliding member.

7. The detacher as claimed in claim 3, wherein the driving member is provided with a pin at one end of the screw portion facing the second end of the main body, the pin protrudes toward the second end of the main body and is inserted into the sliding member.

8. The detacher as claimed in claim 4, wherein the driving member is provided with a pin at one end of the screw portion facing the second end of the main body, the pin protrudes toward the second end of the main body and is inserted into the sliding member.

9. The detacher as claimed in claim 1, wherein the fixed jaw is provided on a bottom side of the main body; a through groove penetrates through a top side and the bottom side of the main body; the movable jaw of the sliding member passes through the through groove to reach the bottom side of the main body.

10. The detacher as claimed in claim 1, wherein a perforation is provided in the sliding member along the moving direction and penetrates through the sliding member; one end of the screw portion facing the second end of the main body is provided with a pin along an axial direction of the screw portion, the pin is inserted into the perforation of the sliding member and protrudes from the sliding member; an accommodating space is disposed on a top side of the main body and located between the sliding member and the second end; when the driving member displaces toward the second end of the main body, the pin is capable of moving into the accommodating space.

11. The detacher as claimed in claim 2, wherein a perforation is provided in the sliding member along the moving direction and penetrates through the sliding member; one end of the screw portion facing the second end of the main body is provided with a pin along an axial direction of the screw portion, the pin is inserted into the perforation of the sliding member and protrudes from the sliding member; an accommodating space is disposed on a top side of the main body and located between the sliding member and the second end; when the driving member displaces toward the second end of the main body, the pin is capable of moving into the accommodating space.

12. The detacher as claimed in claim 3, wherein a perforation is provided in the sliding member along the moving direction and penetrates through the sliding member; one end of the screw portion facing the second end of the main body is provided with a pin along an axial direction of the screw portion, the pin is inserted into the perforation of the sliding member and protrudes from the sliding member; an accommodating space is disposed on a top side of the main body and located between the sliding member and the second end; when the driving member displaces toward the second end of the main body, the pin is capable of moving into the accommodating space.

13. The detacher as claimed in claim 4, wherein a perforation is provided in the sliding member along the moving direction and penetrates through the sliding member; one end of the screw portion facing the second end of the main body is provided with a pin along an axial direction of the screw portion, the pin is inserted into the perforation of the sliding member and protrudes from the sliding member; an accommodating space is disposed on a top side of the main body and located between the sliding member and the second end; when the driving member displaces toward the second end of the main body, the pin is capable of moving into the accommodating space.

14. The detacher as claimed in claim 10, wherein the second end of the main body is provided with a receiving chamber communicating with the accommodating space.

15. The detacher as claimed in claim 1, wherein when the driving member is rotated, the driving member is capable of displacing toward the first end of the main body along the moving direction, and the driving member drives the sliding member to displace toward the first end of the main body, so that the movable jaw is away from the fixed jaw.

16. The detacher as claimed in claim 15, wherein the sliding member is provided with a perforation along the moving direction; one end of the screw portion facing the second end of the main body is provided with a pin along the axial direction of the screw portion, the pin is inserted into the perforation of the sliding member; a second driving portion is provided on the pin and contacts with the sliding member, the driving member drives the sliding member to displace toward the first end via the second driving portion.

17. The detacher as claimed in claim 1, further comprising a grip connected to the main body.

18. The detacher as claimed in claim 1, wherein the main body is provided with a pivotal portion.
